(19) United States
(12) Patent Application Publication
(10) Pub. No.: US 2009/0178771 A1
(43) Pub. Date: Jul. 16, 2009

(54) VEHICLE SUNSHADE ASSEMBLY

(75) Inventor: Paul Lin, Tainan Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: MACAUTO INDUSTRIAL CO., LTD., Tainan Hsien (TW)

(21) Appl. No.: 12/014,704

(22) Filed: Jan. 15, 2008

(51) Int. Cl. B60J 1/20; B60J 3/00

(52) U.S. Cl. 160/370.22; 296/97.8; 296/97.9

(57) ABSTRACT

A sunshade assembly includes a roller, a pair of rails, and a screen unit. Each rail includes an upper wall, and a lower wall cooperating with the upper wall to define a recess therebetween. A screen unit includes a screen having opposite peripheral edge portions and operable between a wound state and an extended state, and a pair of abutment pieces. Each abutment piece is slidably disposed in the recess, and includes an arcuate first portion fixed to a respective one of the peripheral edge portions of the screen and abutting against the lower wall of the respective rail, and a second portion. The first portion arches downwardly in a normal state, and arches upwardly in an abnormal state caused by pulling of the screen. The second portion abuts against the lower wall in the normal state and against the upper wall in the abnormal state.

### BACKGROUND OF THE INVENTION

1. Field of the Invention

The invention relates to a sunshade, more particularly to a sunshade assembly for vehicles.

2. Description of the Related Art

As illustrated in FIG. 1, a conventional vehicle sunshade 1 that may be assembled to a vehicle sunroof (not shown) comprises a retracting unit 11, a pair of rails 12, and a screen 13 that is operable between a wound state, where the screen 13 is wound on the retracting unit 11, and an extended state, where the screen 13 is advanced along the pair of rails 12. In order to prevent the screen 13 from being removed from the rails 12 as a result of sudden and excessive wind forces entering through the sunroof or by being struck by a person in the vehicle, a plurality of ball-shaped members 14 are fixed to the opposite lateral edges of the screen 13. Through design of the ball-shaped members 14 such that they are larger than slide openings 120 in the rails 12, the screen 13 is prevented from being removed from the rails 12. However, such a design of mounting a plurality of the ball-shaped members 14 to the screen 13 makes assembly and manufacture of the sunshade 1 difficult. FIGS. 2 and 3 illustrate another conventional vehicle sunshade that utilizes a different design for preventing a screen 21 from being removed from rails 22. In this configuration, angled flexible strips 23 are mounted respectively on opposite lateral edges of the screen 21. By insertion of the strips 23 in recesses 220 in the rails 22, the screen 21 can flexibly urge against the top and bottom walls of the rails 22 so as to prevent the screen 21 from being removed from the rails 22. However, because the strips 23 are formed as flat sheet-like elements, the strips 23 deform easily when a force is applied to the strips 23 in a direction toward the opposite rail 22 as a result of the screen 21 being pulled. If this occurs, the screen 21 can be easily removed from the recesses 220 in the rails 22.

### SUMMARY OF THE INVENTION

It is an object of the present invention to provide a sunshade assembly that can overcome the above drawbacks of the prior art.

A sunshade assembly of this invention includes a roller, a pair of rails, and a screen unit. Each rail includes an upper wall, and a lower wall cooperating with the upper wall to define a recess and an opening therebetween. The opening is in spatial communication with the recess and faces the other of the rails. The screen unit includes a screen and a pair of abutment pieces. The screen has opposite peripheral edge portions and is operable between a wound state where the screen is wound on the roller, and an extended state where the screen is unwound from the roller. Each abutment piece is slidably disposed in the recess in a respective one of the rails, and includes an arcuate first portion fixed to a respective one of the peripheral edge portions of the screen and abutting against the lower wall of the respective one of the rails, and a second portion extending freely from the first portion. The first portion arches downwardly in a normal state, and arches upwardly in an abnormal state caused by pulling of the screen. The second portion abuts against the lower wall of the respective one of the rails in the normal state and against the upper wall of the respective one of the rails in the abnormal state.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional vehicle sunshade;

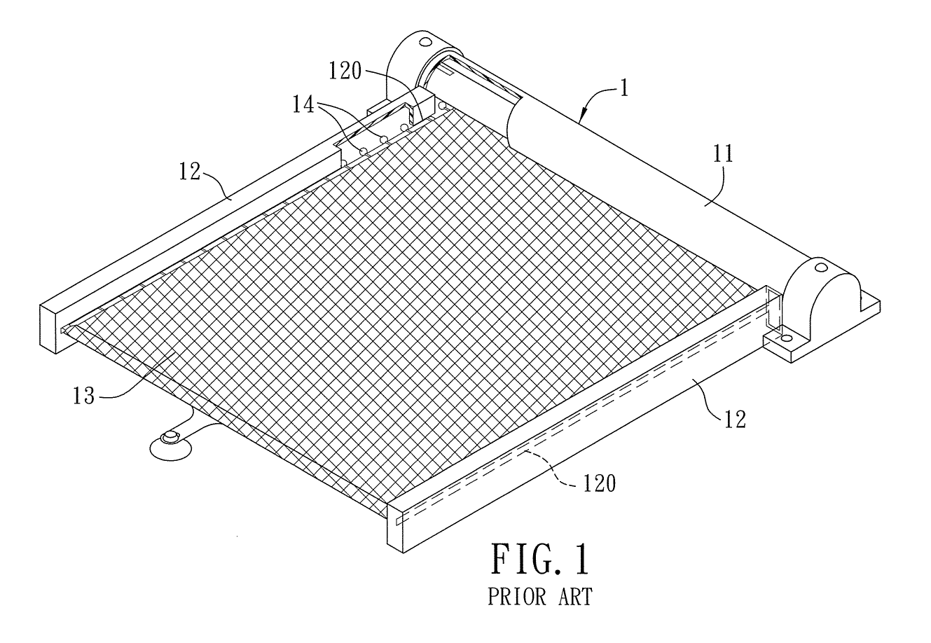

FIG. 2 is a fragmentary perspective view of another conventional vehicle sunshade;

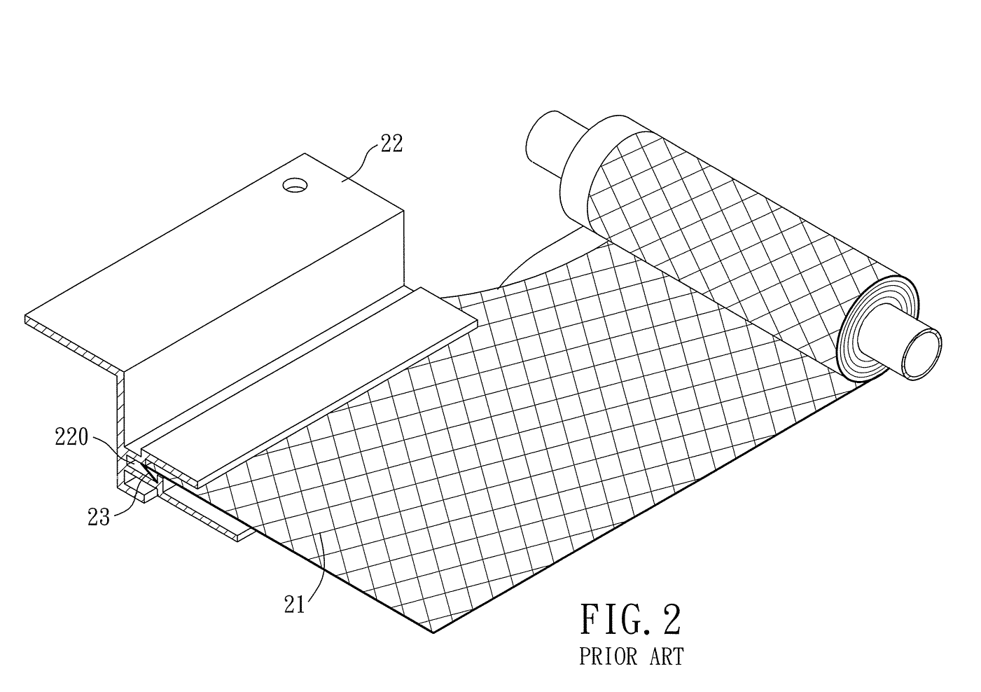

FIG. 3 is a fragmentary sectional view of the conventional vehicle sunshade of FIG. 2;

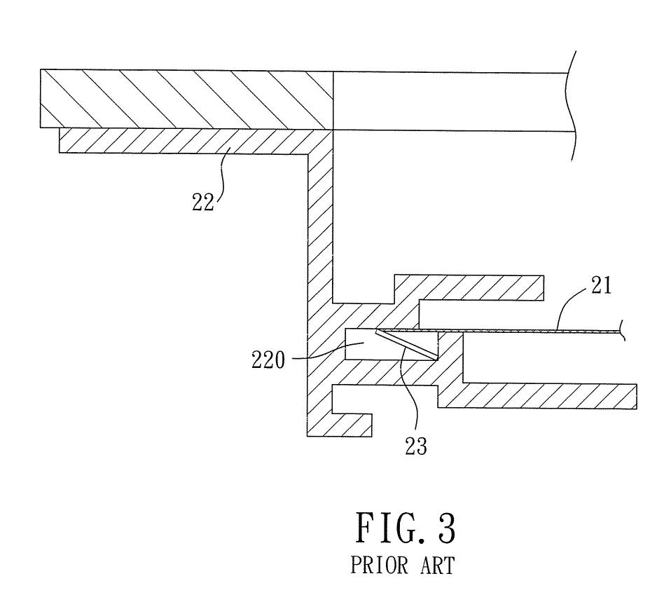

FIG. 4 is a perspective view of the preferred embodiment of a vehicle sunshade assembly shown in a state mounted to a sunroof of a vehicle;

FIG. 5 is a perspective view of the preferred embodiment in a wound state;

FIG. 6 is a fragmentary perspective view of the preferred embodiment in an extended state;

FIG. 7 is a fragmentary sectional view of the preferred embodiment in the extended state under normal operating conditions; and

FIG. 8 is a view similar to FIG. 7, but depicting the vehicle sunshade assembly being securely engaged in a rail in the extended state under abnormal operating conditions.

### DETAILED DESCRIPTION OF THE PREFERRED EMBODIMENT

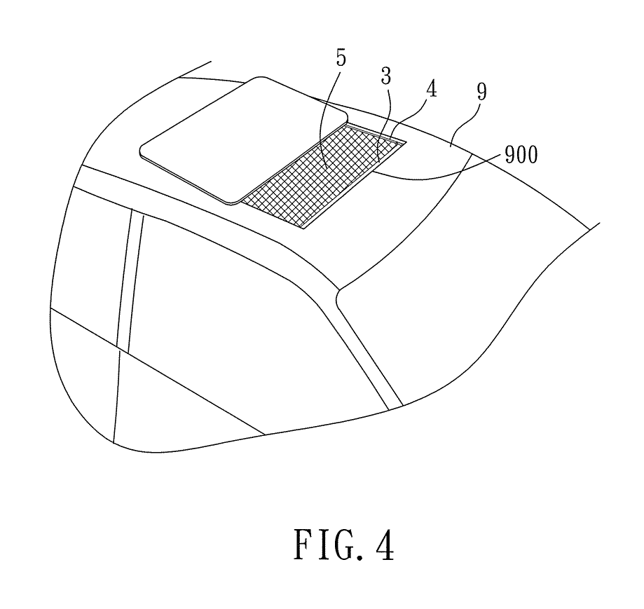

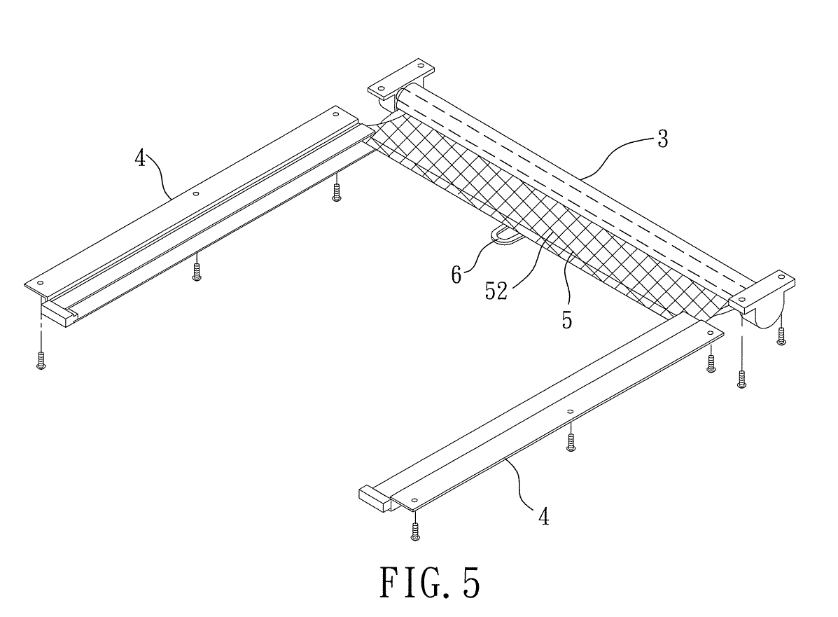

As shown in FIGS. 4, 5, and 6, the preferred embodiment of a sunshade assembly of the present invention is adapted to be assembled on a sunroof 900 of a vehicle 9 to thereby selectively cover the sunroof 900.

The sunshade assembly includes a roller 3, a pair of rails 4, a screen unit 5, and a loop 6. The roller 3 is continuously biased to rotate in a winding direction. Since the construction of the roller 3 is known to those skilled in the art and is not the primary feature of the present invention, a detailed description of the same will be dispensed with herein for the sake of brevity.

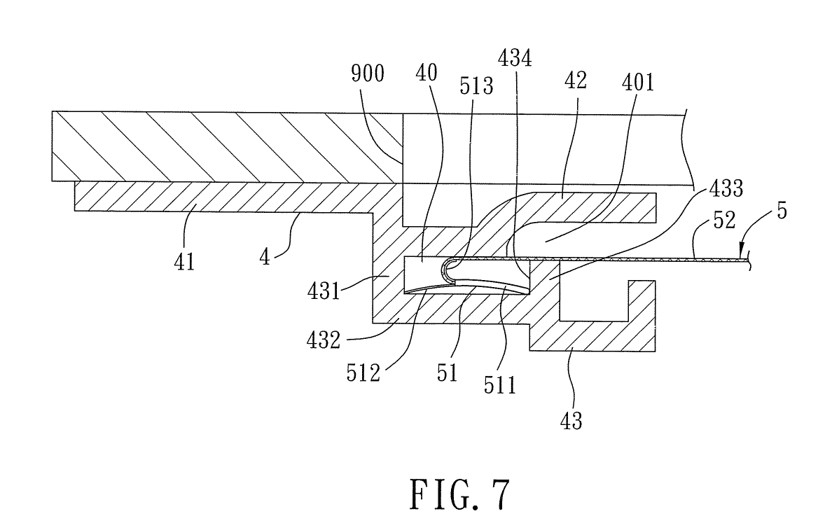

With additional reference to FIG. 7, each rail 4 includes an upper wall 42, and a lower wall 43 cooperating with the upper wall 42 to define a recess 40 and an opening 401 therebetween. The opening 401 is in spatial communication with the recess 40 and faces the other of the rails 4.

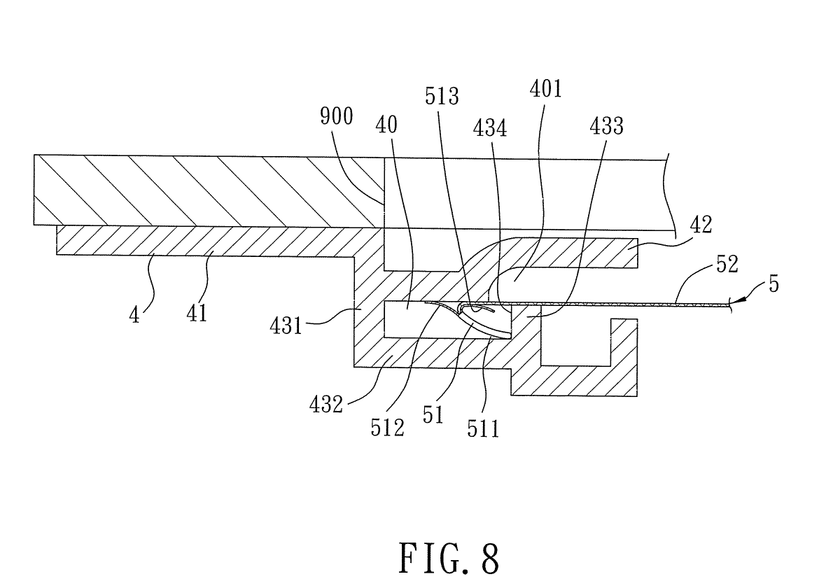

The screen unit 5 includes a screen 52 and a pair of abutment pieces 51. The screen 52 has opposite peripheral edge portions, and is operable between a wound state where the screen 52 is wound on the roller 3, and an extended state where the screen 52 is unwound from the roller 3. Each abutment piece 51 is slidably disposed in the recess 40 in a respective one of the rails 4, and includes an arcuate first portion 511 fixed to a respective one of the peripheral edge portions of the screen 52 and abutting against the lower wall 43 of the respective one of the rails 4, and a second portion 512 extending freely from the first portion 511. As best shown in FIGS. 7 and 8, the first portion 511 arches downwardly in a normal state, and arches upwardly in an abnormal state caused by excessive pulling of the screen 52. The second portion 512 abuts against the lower wall 43 of the respective one of the rails 4 in the normal state and against the upper wall 42 of the respective one of the rails 4 in the abnormal state.

The lower wall 43 of each of the rails 4 includes a connecting portion 431, a horizontal portion 432, and a limiting portion 433. The connecting portion 431 is fixed to a bottom surface of the upper wall 42. The horizontal portion 432 extends from the connecting portion 431 toward the opposite one of the rails 4 and is spaced apart from the upper wall 42. The limiting portion 433 is opposite to the connecting portion 431, extends upwardly from the horizontal portion 432 toward the bottom surface of the upper wall 42, and has a limiting surface 434 facing the connecting portion 431. The connecting portion 431, the horizontal portion 432, the limiting portion 433, and the upper wall 42 cooperatively define the recess 40. The opening 401 is defined between an upper end of the limiting portion 433 and the upper wall 42 for extending a respective one of the peripheral edge portions of the screen 52 into the recess 40. The first portion 511 of a respective one of the abutment pieces 51 abuts against the limiting surface 434 of the limiting portion 433. Each of the abutment pieces 51 further includes a third portion 513 extending freely from the first portion 511 and spaced apart vertically from the second portion 512. The third portion 513 is directed upwardly to be resiliently urged against a bottom surface of the screen 52 so that the screen 52 is resiliently deflected upwardly away from the first portion 511.

In the preferred embodiment, each of the abutment pieces 51 is fabricated from a plastic material. Furthermore, in the preferred embodiment, each of the abutment pieces 51 and a respective one of the peripheral edge portions of the screen 52 are thermally fused together.

In the preferred embodiment, each of the rails 4 further includes a fixing wall 41 fixed to the upper wall 42. The fixing walls 41 may be used to mount the sunshade assembly to the sunroof 900 of the vehicle 9.

In order to provide the abutment pieces 51 with a sufficient degree of rigidity so that the abutment pieces 51 can be flexibly deflected in the recesses 40, the following processes may be employed during the manufacture of the screen unit 5. The first step is to obtain a piece of plastic sheet. Second, two plastic strips are obtained and each is folded equally in half. Third, the opposite peripheral edges of the plastic sheet are respectively sandwiched by the folded plastic strips. Finally, select portions of the plastic strips are thermally fused to the plastic sheet. The areas where the plastic strips and the plastic sheet are thermally fused together arch downwardly to thereby form the first portions 511 of the abutment pieces 51. The areas of the plastic strips that are not thermally fused to the plastic sheet form the second and third portions 512, 513.

In one embodiment, each of the abutment pieces 51 is formed by adhering three plastic material layers together so that the rigidity of the abutment pieces 51 is enhanced, and so that the abutment pieces 51 can flexibly deflect in the recesses 40. It should be noted that the manufacture of the screen unit 5 is not limited to the processes described above.

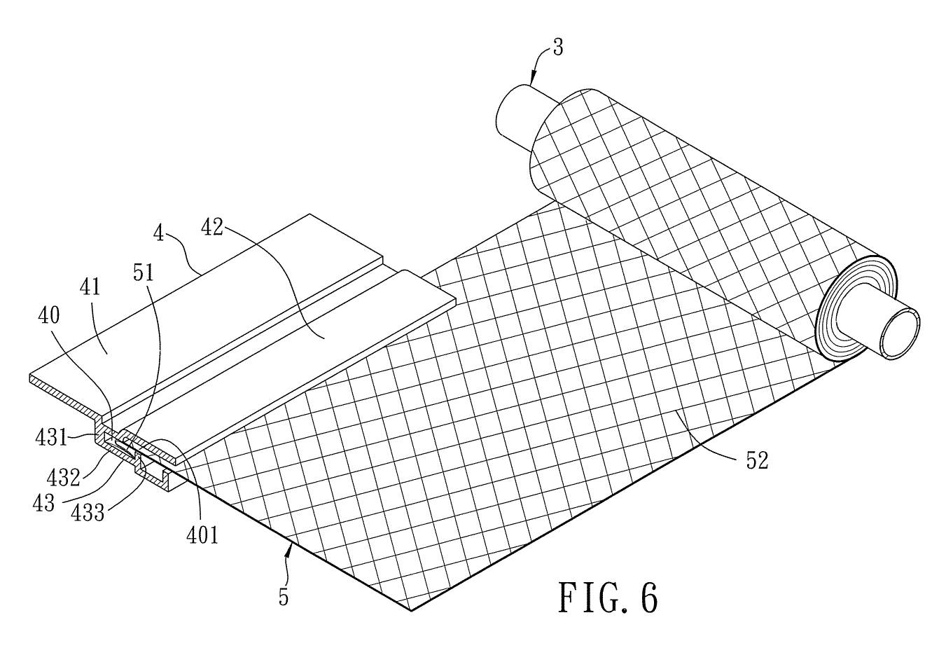

The loop 6 is mounted fixedly on one end of the screen 52 so as to enable the screen unit 5 to be pulled and clasped onto a hanger (not shown) that is disposed in the passenger compartment of the vehicle. In such a state, the screen assembly 5 is extended to cover the sunroof 900, as best shown in FIG. 4. Reference is now made to FIGS. 6 to 8 to describe the operation of the sunshade assembly. In the extended state where the screen unit 5 is advanced along the rails 4 to cover the sunroof 900, if the screen unit 5 receives deflection forces as a result of being struck by a passenger or being acted upon by wind forces entering through the sunroof 900, the screen 52 moves upward or downward to thereby pull on the abutment pieces 51. Assuming that such deflection forces are not excessive, since the first portions 511 arch downwardly, when pulled, the first portions 511 press respectively against the limiting surfaces 434 of the limiting portions 433, while at the same time, the second portions 512 press respectively against the connection portions 431 of the lower walls 43. In addition, due to the construction and shape of the first portions 511, the first portions 511 do not buckle easily in an upward direction.

Referring to FIG. 8, if such deflection forces acting on the screen unit 5 become excessive, the abutment pieces 51 are changed to the abnormal state. That is, if the screen 52 pulls on the abutment pieces 51 by an amount that exceeds a predetermined threshold level, the first portions 511 flexibly buckle in an upward direction. If this occurs, the second portions 512 are displaced upward to urge against the bottom surfaces of the top walls 42. In this state, the abutment pieces 51 are prevented from being removed from the recesses 40, as best shown in FIG. 8.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sunshade assembly, comprising:
a roller;
a pair of rails each including an upper wall, and a lower wall cooperating with said upper wall to define a recess and an opening therebetween, said opening being in spatial communication with said recess and facing the other of said rails; and
a screen unit including
a screen having opposite peripheral edge portions and operable between a wound state where said screen is wound on said roller, and an extended state where said screen is unwound from said roller, and
a pair of abutment pieces each slidably disposed in said recess in a respective one of said rails, and including an arcuate first portion fixed to a respective one of said peripheral edge portions of said screen and abutting against said lower wall of the respective one of said rails, and a second portion extending freely from said first portion,
said first portion arching downwardly in a normal state, and arching upwardly in an abnormal state caused by excessive pulling of said screen, said second portion abutting against said lower wall of the respective one of said rails in the normal state and against said upper wall of the respective one of said rails in the abnormal state.

2. The sunshade assembly as claimed in claim 1, wherein said lower wall of each of said rails includes
a connecting portion fixed to a bottom surface of said upper wall,
a horizontal portion extending from said connecting portion toward the opposite one of said rails and spaced apart from said upper wall, and
a limiting portion opposite to said connecting portion, extending upwardly from said horizontal portion toward said bottom surface of said upper wall, and having a limiting surface facing said connecting portion,
said connecting portion, said horizontal portion, said limiting portion, and said upper wall cooperatively defining said recess, said opening being defined between an upper end of said limiting portion and said upper wall for extending a respective one of said peripheral edge portions of said screen into said recess, said first portion of a respective one of said abutment pieces abutting against said limiting surface of said limiting portion.

3. The sunshade assembly as claimed in claim 2, wherein each of said abutment pieces further includes a third portion extending freely from said first portion and spaced apart vertically from said second portion, said third portion being directed upwardly to be resiliently urged against a bottom surface of said screen so that said screen is resiliently deflected upwardly away from said first portion.

4. The sunshade assembly as claimed in claim 1, wherein each of said abutment pieces is fabricated from a plastic material.

5. The sunshade assembly as claimed in claim 1, wherein each of said abutment pieces and a respective one of said peripheral edge portions of said screen are thermally fused together.

6. The sunshade assembly as claimed in claim 1, wherein each of said rails further includes a fixing wall fixed to said upper wall.
